(19) United States
(12) Patent Application Publication
(10) Pub. No.: US 2024/0198727 A1
(43) Pub. Date: Jun. 20, 2024

(54) CONTROLLER AND METHOD FOR CONTROLLING CASTERS ATTACHED TO A MOVABLE PART

(71) Applicant: TENTE GmbH & Co. KG, Wermelskirchen (DE)

(72) Inventor: Lars LANGBEIN, Wermelskirchen (DE)

(73) Assignee: TENTE GmbH & Co. KG, Wermelskirchen (DE)

(21) Appl. No.: 18/288,419

(22) PCT Filed: Apr. 28, 2022
(86) PCT No.: PCT/EP2022/061402

§ 371 Date: Oct. 26, 2023

(30) Foreign Application Priority Data
Apr. 30, 2021 (DE) 10 2021 111 256.7
Mar. 18, 2022 (DE) 10 2022 106 363.1

(51) Int. Cl. B60B 33/02; A61G 7/05; A61G 7/08; B60B 33/00

(52) U.S. Cl. CPC B60B 33/028; A61G 7/0528; A61G 7/08; B60B 33/0092; B60B 33/021; B60B 33/026; A61G 2203/36; B60B 2200/242; B60B 2900/331; B60B 2900/531

(57) ABSTRACT

A controller and a method for controlling casters attached to a movable part such as a hospital bed, for switching the castors between a state in which the castor is pivot locked and rotationally blocked, and a state in which there is neither a pivot locking nor a rotational blocking, additionally switchable into a state in which the caster is only pivot locked, actuatable electrically and also manually, movement sensor. Multiple switching states may be automatically and sequentially assumed in a predetermined sequence, a first switching state in which there is neither a pivot locking nor a rotational blocking, which a second switching state, in which one or more or all castors are pivot locked, however not rotationally blocked, and finally a switching state, in which all switchable casters are again pivot locked and rotationally blocked.

### CROSS REFERENCE TO RELATED APPLICATIONS

This application is the National Stage of PCT/EP2022/061402 filed on Apr. 28, 2022, which claims priority under 35 U.S.C. § 119 of German Application No. 10 2021 111 256.7 filed on Apr. 30, 2021 and German Application No. 10 2022 106 363.1 filed Mar. 18, 2022, the disclosures of which are incorporated by reference. The international application under PCT article 21(2) was not published in English.

### TECHNICAL FIELD

The invention relates to a controller of casters attached to a movable part, for example, a hospital bed, wherein two or more casters are switchable by means of a switching device for switching the casters between a state in which the caster is pivot locked and a wheel of the caster is rotationally blocked and a state in which there is neither a pivot locking nor a rotational block, wherein furthermore one of the casters is additionally switchable into a state in which the caster is only pivot locked, wherein the switchable casters may be actuated electrically and manually and the movable part has a movement sensor.

Furthermore, the invention relates to a method for controlling casters attached to a movable part, for example, a hospital bed, wherein two or more casters are switchable by means of a switching device for switching the casters between a state in which the caster is pivot locked and a wheel of the caster is rotationally blocked and a state in which there is neither a pivot locking nor a rotational block, wherein furthermore one of the casters is additionally switchable into a state in which the caster is only pivot locked, wherein the switchable casters may be actuated electrically and manually and the movable part has a movement sensor.

### PRIOR ART

Movable parts of the type in question are known, for example, as hospital beds or also in the form of transport vehicles. Such movable parts generally have four casters arranged in the corner areas of the movable part. Reference is made, for example, to WO 02/055322 A1 (U.S. Pat. No. 7,200,894 B2). In addition, movable parts are also known with, for example, three casters spanning a geometric triangle in a top view due to their arrangement.

Casters for such movable parts are known, for example, from WO 2008/055831 A1 (US 2010/0077562 A1) or WO 2012/171814 A1 (US 2014/0109342 A1).

A controller and a method for controlling these types of casters is furthermore known, for example, from WO 2015/071076 A1 (US 2016/0297242 A1).

A controller is known from U.S. Pat. No. 10,568,792 B2 for casters attached to a movable part, for example, a hospital bed, in which, starting from a rotational blocking of the casters by an application of pressure of the movable part, a transfer to a state is carried out in which there is neither a pivot locking nor a rotational blocking. An assumption of a rotationally blocked state of the casters is only carried out with respect to the application of force.

In addition, with respect to the prior art, reference with respect to the casters is fundamentally made to EP 3 552 592 A1 and US 2008/234913 A1.

### SUMMARY OF THE INVENTION

Starting from the prior art as it is known, for example, from cited U.S. Pat. No. 10,568,792 B2, the invention is concerned with the task of specifying an advantageous controller of the casters and an advantageous method for controlling the same.

This problem is solved with respect to the controller by switchable casters in that, starting from a state in which the switchable casters are pivot locked and rotationally blocked, following a triggering event, multiple switching states may be automatically and sequentially assumed in a predetermined sequence, wherein a first switching state transfers all casters into the state in which there is neither a pivot locking nor a rotational block, which a second switching state may automatically follow, in which second state one or multiple or all casters are pivot locked, however their wheels are not rotationally blocked, and finally a switching state follows, after an absence of a detection of a movement of the movable part, in which all switchable casters are again transferred into the state in which they are pivot locked and rotationally blocked, and that the triggering event is a switch actuation by an operator.

With respect to the method, the problem is solved wherein, with respect to a desired movement of the movable part using the casters on the movable part, in the sense that a triggering event is enacted by actuating a switch by which means a previously determined sequence of different switching states of the casters is triggered, wherein all casters are initially transferred into a release position, which an automatic pivot locking of one or more or all casters follows, and finally, after an absence of a detection of a movement of the movable part, all casters, which are switchable between a rotational blocking and pivot locking and a release position, are switched into the rotational blocking and pivot locking.

An improved handling as part of a displacement or shunting of the movable part by an operator is provided by the proposed controller and by the specified method for controlling as a result of a triggering event, starting from a total locking of the casters of the movable part, in which there is both a pivot locking of one, preferably each of the casters of the movable part, and also a rotational blocking of the wheel assigned to the casters, again preferably for each of the casters of the movable part. A manual switching between the different switching positions by the operator may be omitted. Rather, this type of switching is preferably achieved solely due to the controller. The triggering event for starting the controller may thereby be, as is also further preferred, solely achieved by an intentional action by the operator.

As a result of this triggering, the casters are initially brought out of their total locking into a switching state in which there is neither a pivot locking nor a rotational blocking. Correspondingly, the movable part may be freely moved or maneuvered. From this switching state, the controller is automatically able to switch at least one of the casters, preferably two or more, into a pivot locking, such that a straight-line travel of the movable part is then supported. Such a switch from the free switching state into the pivot locking switching state may be brought about automatically by the controller after a corresponding determination of a desired straight-line travel of the movable part. Thus, after determining a straight-line travel of the movable part over an, optionally, predetermined travel path, such an automatic switch into the pivot locking switching state may be achieved.

From this switching state supporting straight-line travel, in particular during a stopping of the movable part after such a straight-line travel, a switch back into the switching state offering free mobility of the movable part may be carried out via the control sequence.

Finally, the initial state, namely the total locking, in which all switchable casters are again pivot locked and rotationally blocked, may be automatically achieved via the controller. Thus, for example, this final switching state may furthermore be achieved after the absence of a detection of a movement of the movable part, or if practically no movement is detected, corresponding to the detection of a stopping of the same, so that as a result it is ensured, according to the proposed controller, that the casters of a movable part, switched off by the operator, are automatically switched into the total locking position.

Upon reaching this switching state again, in which there is both a rotational blocking and a pivot locking, the relevant control sequence is ended. A renewed sequence of the controller, as described above, may be possible, optionally, only after a renewed triggering event.

According to one possible embodiment, the event triggering the sequence of the controller may be solely the attempt by the operator to set the movable part into movement. For this purpose, a switch, which acts on the controller so that the automated sequence begins, may be provided on the movable part. Accordingly, this is preferably an event that ensures the authorization to start the control sequence. Correspondingly, where appropriate, only a limited user group may trigger the control sequence.

According to a preferred embodiment, the triggering event is thus only effective after a security check. Such a safety check may be carried out in particular to determine whether a displacement of the movable part is intentional and/or to determine an authorization for displacing the movable part. The security check may therefore first be activatable by the operator, for example by actuating a switch. The security check is preferably active for the immediate detection of a signal that legitimately triggers the event.

Optionally, after such a security check, the triggering event may be achieved by a switch actuation by an operator. A positive security check itself, for example the recognition of a fingerprint by means of a fingerprint sensor provided on the movable part and connected to the controller, or the recognition of a face or an eye by a facial or iris scanner connected to the controller of the movable part and preferably provided on the movable part, may already be the triggering event. The intention of the operator to move the movable part is made clear as a result of, for example, a switch actuation, but also even the cited detection itself. By actuating the switch, for example, or with the cited recognition, the control sequence starts automatically, in that an initial pivoting release and also a rotational release of the casters is carried out from the preferred total locking of the casters.

The previously-described security check may also be carried out, for example, by means of a transponder and/or by entering a code. Correspondingly, the security check may be a recognition of an authorized operator. Authorization may be checked using a finger scanning sensor in comparison with fingerprints preferably stored in a database. In the case of a positive result, the control sequence may correspondingly be started as described. The proof of authorization may also be provided, for example, by an RFID chip worn on or in the clothing of the operator, which may be detected by a transponder on the movable part. In addition, the movable part may have, for example, a numeric or alphanumeric keyboard, via which an authorization code for starting the control sequence may be entered.

The switching devices of the switchable casters may be actuated by an electric motor. In order to be able to carry out an emergency switching actuation of one or more or all casters in the event of a failure of such an electric drive or a plurality of such electric drives or in the event of a failure of an electrical supply, a manual actuation of such a switching device is possible in addition to the actuation by electric motor. Where appropriate, the means of the electric motor acting on the switching device may be overridden for emergency switching operation. Alternatively, with the corresponding arrangement, the electric motor itself may be used as a handle for manual operation. Such an emergency actuation is known from WO 02/055322 A1, cited at the onset. In addition, reference is also made to WO 2012/171814 A1, cited at the outset.

The electric motor for actuating the switching device may interact directly or indirectly with switches and limit switches, which generate a signal upon reaching the selected position corresponding to the selected switching state or upon leaving such a position.

The number of such switches may, as is also preferred, be adapted to the number of possible switching states, so that with three possible switching states, three switches may be arranged in the form of limit switches.

Alternatively to detecting the switching positions by means of switches, it may also be provided that the electric motor is referenced electronically when it is used for the first time or also in the course of a triggering event, for example, as a result of a detection of a maximum motor current in two preferably stop-limited end positions, which more preferably correspond to two switching positions. An intermediate position (for example a neutral position in which the switchable casters are neither pivot locked nor rotationally blocked) may then be reached in a targeted manner starting from one of the other switching positions (end position) by a time-limited actuation of the electric motor. Correspondingly, the electric motor may safely approach the switching positions, which are stored in the control software, even without position-detecting switches.

Two or more, up to all, casters of the movable part may be switchable via a shift linkage. For example, two front or rear casters of the movable part, in the usual direction of travel of the movable part, may be mutually switched, manually or via an electric motor, via a switching rod running transverse to the usual direction of travel. The front and rear pair of casters, which are each switchably connected to one another via a switching rod, may also be switchably connected to one another via a further switching rod aligned in the usual direction of travel, so that only one common electric motor may be provided for switching preferably all casters of the movable part.

In a manner that is advantageous in terms of handling, after a successful triggering of the sequence and, where appropriate, in the case that one or more casters are in a pivot locking position, the pivot locking may be released again by repeating the triggering event or by a separate actuation, for example, a separate switch actuation, whereupon all casters are in the release position. Correspondingly, the triggered predefined control sequence may be interrupted or reset by one sequence step by intentional triggering by the operator. This may lead to a termination of the automatically predetermined control sequence. In this regard, however, merely resetting the control sequence to the first switching state, in which there is neither a pivot locking nor a rotational blocking, is preferred. Starting from this reset control sequence step, the control sequence continues, as described above, with the second switching state (pivot locking) and the final switching state (total locking).

Alternatively, in the case of such a separate actuation, the total locking may occur as the next switching state, when the (essential) stopping of the movable part is determined.

To reset the control sequence, an identical triggering event, as is used for activating the control sequence, may be a prerequisite, alternatively, however, a different event may also be the prerequisite. In another alternative embodiment, a switch or a button or the like may be provided, preferably only for resetting the control sequence.

Such a repetition of the triggering event, as well as the separate actuation during the automated sequence of the switching states, is more preferably efficient without a (renewed) safety check.

The predetermined sequence between the switching states of the control sequence may, as further preferred, respectively include a predetermined period of time. Thus, after the total release of the casters in the first switching state, a straight-line travel of the movable part is monitored over a predetermined period of time. When the period of time has elapsed, and after (only) a straight-line travel has been detected within the period of time, the switching into the second switching state is preferably carried out, in which at least one caster is pivot locked and then acts as a so-called fixed caster. Starting from this second switching state, during a subsequently determined stopping of the movable part, this stopping is initially monitored for a predetermined period of time and afterwards, optionally, the first switching state is assumed for the free movement of the movable part. With the expiration of a further period of time extending beyond the period of time, in which the stopping of the movable part is still detected, the third switching state (total locking) is preferably assumed.

The period of time for detecting a switching point between the first switching state and the second switching state or between the second switching state and the third switching state may be the same; however, where appropriate, they may also differ. The period of time may thereby be, for example, approximately 1 to 10 seconds, further, for example, 2 to 5 seconds. More preferably, the period of time may be adjustable, optionally, freely selectable or freely programmable. The period of time may also be significantly longer, for example up to 20 or 30 seconds or even up to one minute or several minutes.

According to a further preferred embodiment, one or more preferably electronic motion or acceleration sensors may be provided on the movable part to detect the movement of the movable part and more preferably the direction of travel of the movable part.

According to another possible embodiment, after a triggering event and assumption of the first switching state, in which there is a free movement of the movable part as a result of the release of the pivot locking as well as the rotational blocking, the third and thus the initial state (total locking) may be assumed immediately by skipping the second switching state, provided that, after switching into the first switching state, no displacement of the movable part is detected within a predetermined time window.

In one possible embodiment, the three or four casters, directly arranged on the movable part and supported on the ground, may have only two switching positions, namely a rotational blocking position and on the other hand a rotational release position of the wheel. These two positions of the caster may be assumed automatically via the control sequence according to the invention after a triggering event, preferably as a result of an electric motor switching between the positions.

The previously described second switching state, in which at least one caster is pivot locked and thus determines or supports the straight-line travel of the movable part, may supplementally or alternatively also be achieved in that a fourth or fifth caster is provided as an additional caster, which only has one predetermined running direction. Correspondingly, this additional caster is preferably arranged such that this is aligned in a straight-line direction of travel of the movable part during corresponding activation of the same. The additional caster is thereby not pivotable about a vertical axis, but instead is designed as a type of a fixed castor.

Such an additional caster may, as is also preferred, be activatable in that it is movable between a lowered and a raised position. The activation is correspondingly provided in the lowered position. Correspondingly, an activation of the straight-line travel, which is achieved by a pivot locking in the case of the so-called pivot casters, is carried out by lowering such an additional caster. When the third (and preferably last) switching state is triggered, the rotational blocking is activated on the other casters and, where appropriate, on the additional caster that remains in the lowered position in this switching state. Only in the first switching state, in which a free movement of the movable part is desired, is the additional caster raised and correspondingly deactivated.

Although the additional caster is preferably and generally provided as a fixed caster, that is, not pivotable by design, it also depends on where the additional caster is attached to the movable part with regard to a support or to a determination of the straight-line travel. If it is attached in a geometric center between the other casters, it may substantially function only as a point support, around which point support there is, however, free pivoting. In such a case in particular, it is also advantageous if at least one further caster is also directionally locked in said switching state of the directional locking.

In another embodiment, the additional caster, in particular the running wheel of the additional caster, may be drivable, in particular drivable by an electric motor. Such a drive is preferably only activated in the lowered position, to support the operator in moving the movable part.

### BRIEF DESCRIPTION OF THE DRAWINGS

The invention will subsequently be explained in greater detail by way of exemplary embodiments. As shown in:

FIG. 1 a movable part in the form of a hospital bed in perspective depiction, relating to a first embodiment;

FIG. 2 a controller in schematic depiction for casters attached to the movable part;

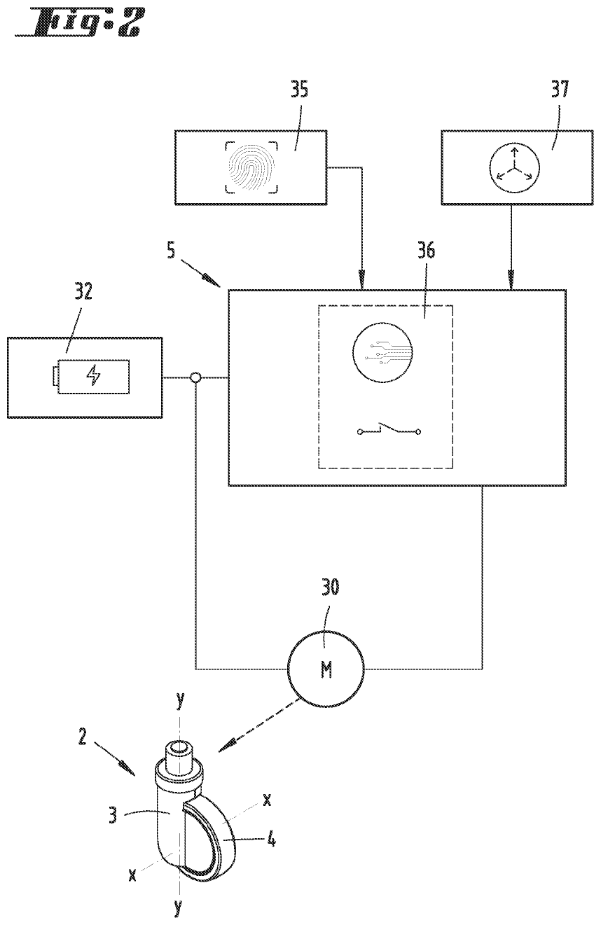

FIG. 3 a schematically depicted control sequence;

FIG. 4 a caster in a vertical sectional view, relating to an initial switching state or a third switching state, in which the caster is pivot locked and rotationally blocked;

FIG. 5 a sectional depiction corresponding to that in FIG. 4, relating to a first switching state, in which the caster is neither pivot locked nor rotationally blocked;

FIG. 6 another sectional depiction corresponding to that in FIG. 4, relating to a second switching state, in which the caster is solely pivot locked;

FIG. 7 a view toward the caster with a partially broken out transmission housing of an attached electric motor drive;

FIG. 8 a shift linkage transferring the switching effect, depicted largely schematically;

FIG. 9 a perspective depiction according to that of FIG. 1 of a movable part, relating to a second embodiment;

FIG. 10 a vertical sectional view through a lowerable, additional caster of the movable part according to FIG. 9 in schematic depiction, relating to the raised position of the additional caster;

FIG. 11 a corresponding depiction of the additional caster corresponding to FIG. 11, relating to the lowered position.

### DETAILED DESCRIPTION OF THE EXEMPLARY EMBODIMENTS

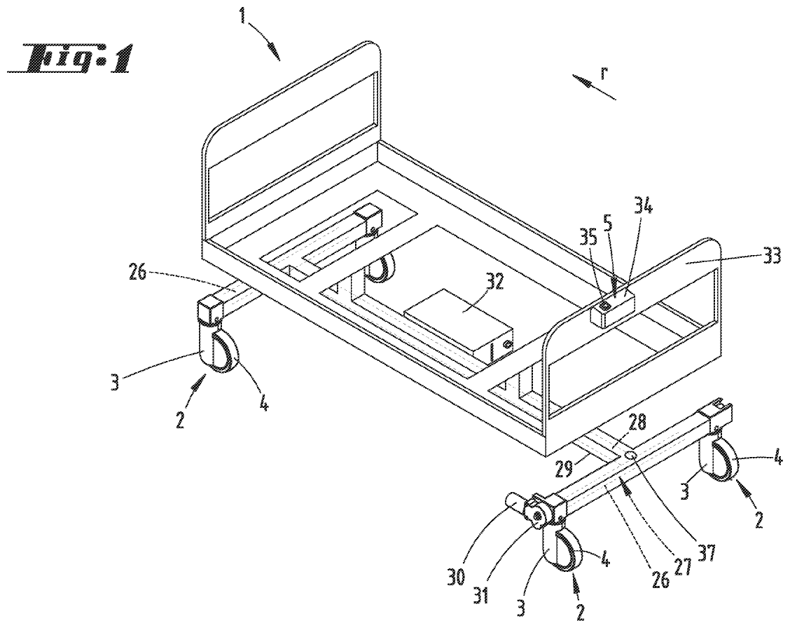

A first exemplary embodiment of a movable part 1 in the form of a hospital bed, depicted here only as a chassis, is depicted and described, initially with respect to the depiction in FIG. 1.

Movable part 1 has four casters 2 assigned to the corner areas of the rectangle substantially spanned in a top view by movable part 1. These casters are designed as lockable steering casters each having a wheel 4 rotatably held in a support housing 3. In the usual arrangement and use position of casters 2, the geometric axes of rotation x of wheels 4 extend substantially in a common horizontal plane. It is possible to pivot support housing 3, together with caster 4, about a pivot axis y perpendicular to said horizontal plane, in order in particular to facilitate a curving travel of movable part 1.

Movable part 1 is provided with a controller 5, via which multiple switching states S1, S2, and S3 of one or more of casters 2 may be automatically assumed in sequence, thus, in particular, a first switching state S1 (release state), in which a pivoting of the respective caster 2 about the pivot axis y and a free rotation of wheel 4 about the axis of rotation x is enabled; further a second switching state S2 (pivot locking state), in which the pivoting of the caster 2 about the pivot axis y is blocked while free rotation of wheel 4 continues; and more preferably a third switching state S3, in which both the rotation of wheel 4 and the pivoting of caster 2 are blocked (total locking state). The various switching states S1, S2, and S3 are automatically sequentially assumed in a predetermined sequence via controller 5.

The different switching positions of switching states S1, S2, and S3 may be detected, for example, via limit switches. These may further interact, for example, with an actuating shaft 26 driven by an electric motor 30. A referencing for path determination may also be carried out, preferably automatically, when using an electric motor 30, as will be subsequently described. This may be a position feedback. The motor may be referenced when starting, and may then move to the positions based on a software-side entry.

In detail, the position feedback may be carried out in such a way that the motor initially approaches a stop at a slow speed. Together with the direction of rotation, which may be detected, the conclusion may then be drawn that it is either the stop assigned to the rotational blocking and pivotal locking, or the stop assigned to the pivot locking alone. During this movement of the motor, the pulses from the position feedback/rotary encoder are evaluated by the controller. If no more pulses are detected over a predetermined period of time, it is assumed that the motor is located at one of the specified stops. The motor then switches off. Afterwards, however, it is more preferably moved out of the end position again by a few pulses, which correspond to incremental distances (wherein the magnitude of such a distance is also preferably adjustable), in order to assume a safe position that does not lead to overloading, even during a following actuation.

Each caster 2 may be held on the chassis of movable part 1 by means of a mounting pin 8 and may be pivoted in this arrangement position about pivot axis y, which is aligned substantially vertically in normal use.

Each caster 2 may be designed, for example, according to WO 2013/023917 A1 or WO 2008/055831 A1 (US 2010/0077562 A1) or WO 2012/171814 A1 (US 2014/0109342 A1) the disclosure of which are all herein incorporated by reference.

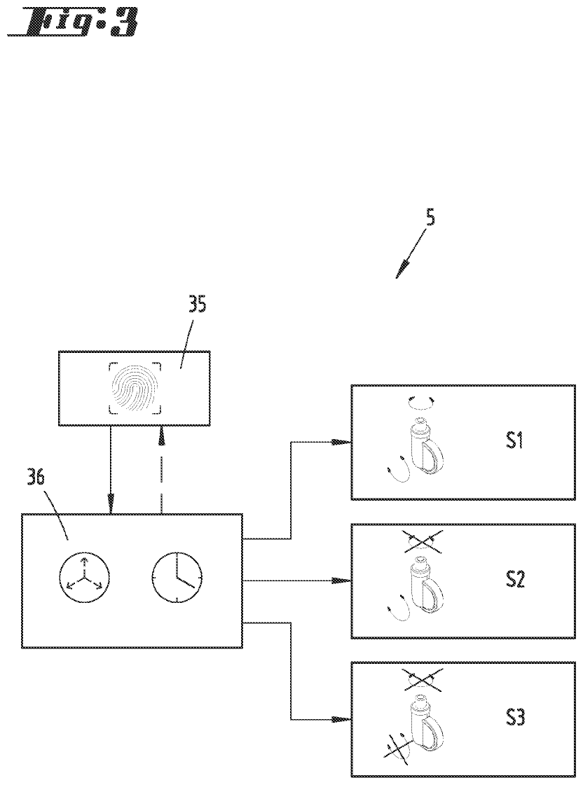

A locking device 6 is arranged in caster 2 (see also FIG. 3) for the parking brake of wheels 2.

In detail, locking device 6 in the exemplary embodiment shown has an interaction surface 7 which interacts with a wheel inner surface 9 in a braking position or in a total locking position.

Furthermore, caster 2 has an actuating tappet 10 which may be moved along pivot axis y in order to actuate locking device 6. The movement is carried out in the exemplary embodiment in particular by a cam wheel 11, which acts on actuating tappet 10 from above and is preferably accommodated to be rotatable in mounting pin 8.

Cam wheel 11 is provided with switch formations 24, 24′ and 24″ arranged on different axial diameter lines with respect to an axis of rotation z of cam wheel 11, for different axial adjustment of actuating tappet 10. A first switch formation 24 is formed directly by the outer wall of cam wheel 11, while the other switch formations 24′ and 24″ are formed by depressions, which start from the outer wall, have different radial dimensions, and are radially aligned with respect to axis of rotation z.

Switch formations 24′ and 24″ are provided in a position one behind the other when viewed in the circumferential direction of cam wheel 11.

Furthermore, cam wheel 11 is provided with a socket 25, in particular a hexagonal socket, through which the geometric axis of rotation centrally penetrates, for rotary actuation of the same about its axis of rotation z.

In further detail, the interaction between locking device 6 and actuating tappet 10 in the exemplary embodiment is provided by means of a guide sleeve 12.

Locking device 6 is further biased into its release position by a return spring 13.

Return spring 13 is arranged laterally offset to actuating tappet 10.

Furthermore, return spring 13 is preferably designed as a compression spring, and, as is clear in the exemplary embodiment, is preferably arranged relative to an interaction with a wheel axle 14, namely being supported thereon.

Actuating tappet 8, which depicts an actuating part, is connected in a rotationally fixed manner to an engagement part 15 for directional locking. For the directional locking, engagement part 15 interacts with an upper first counterpart 16 or a lower second counterpart 17 in a form-fitting or frictional manner for directional locking. The interaction with lower second counterpart 17 is provided in the exemplary embodiment in the case of total locking.

Two roller bearings 22, 23, designed as ball bearings in the depicted exemplary embodiment, are arranged in the area of support housing 3. Engagement part 15 as well as both counterparts 16 and 17 in the exemplary embodiment are arranged within the vertical spacing between roller bearings 18 and 19.

Actuating tappet 10 is provided with a cam part 20 in the area of its upper end. Cam part 20 supports a cam 44 for interaction with one of switching formations 24, 24′, or 24″.

Furthermore, a tappet return spring 21 acts between cam part 20 and guide sleeve 12. Actuating tappet 10 is biased into its release position by means of tappet return spring 21. The release position relates in this case to locking device 6. With regard to the non-rotatable position, it is clear that this spring only biases towards second counterpart 17 into the release position. Concerning first counterpart 16, however, it is biased into the locking position.

Engagement part 15 may have toothed formations (not shown in detail) on the upper side for interacting with counter formations 22 fixed to the housing in the state of the directional locking of caster 2.

Interaction surface 7, which, in the state of a rotational blocking of wheel 4, interacts frictionally with wheel inner surface 9, which preferably consists of a rubber or elastomer material, is provided with tooth formations 23, comparable to the underside of engagement part 15, which are formed extending in the direction of wheel axle 14.

With respect to a usual direction of travel r of movable part 1 in the depicted exemplary embodiment, there are two front casters 2 and two rear casters 2 when viewed in the direction of travel r, wherein cam wheels 11 of casters 2 of a caster pair may be connected to one another via an actuating shaft 26. For this purpose, actuating shaft 26 has a hexagonal cross-section, at least in the area interacting in a form-fitting manner with respective socket 25. Actuating shaft 26 is preferably accommodated in the chassis of movable part 1, which consists more preferably of hollow profiles.

The pivot positions of cam parts 20 of the caster pairs are synchronized via actuating shaft 26.

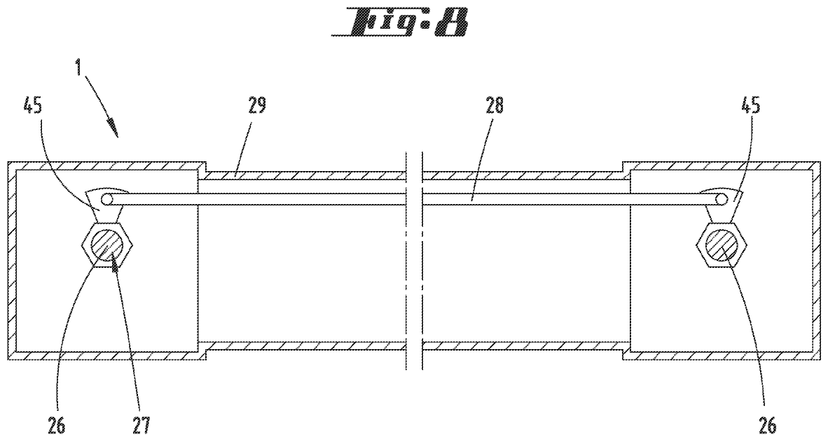

Each actuating shaft 26 may be part of a shift linkage 27, which may additionally include a push rod 28, which may extend in a crossbeam 29 of the chassis that extends in the usual direction of travel r. A movement connection of the two actuating shafts 26, provided, where appropriate, is enabled via this push rod 28. For this purpose, push rod 28 engages in each end in an articulated manner on a lever arm 45 of actuating shaft 26 (see FIG. 8). All four casters 2 may be switched simultaneously and in a synchronized manner via such a shift linkage 27.

The switching of casters 2 is preferably carried out by an electric motor. An electric motor 30 is provided for this purpose, which preferably acts indirectly on respective cam wheel 11 via a high reduction transmission 31 via actuating shaft 26 or shift linkage 27.

Reference is made, for example, to WO 02/055322 A1, mentioned at the outset, with regard to the arrangement and configuration of aforementioned electric motor 30.

An accumulator 32 may serve as the on-board power source for movable part 1, which accumulator may be arranged, for example, on the chassis of movable part 1, for example, farther in the area of crossbeam 29.

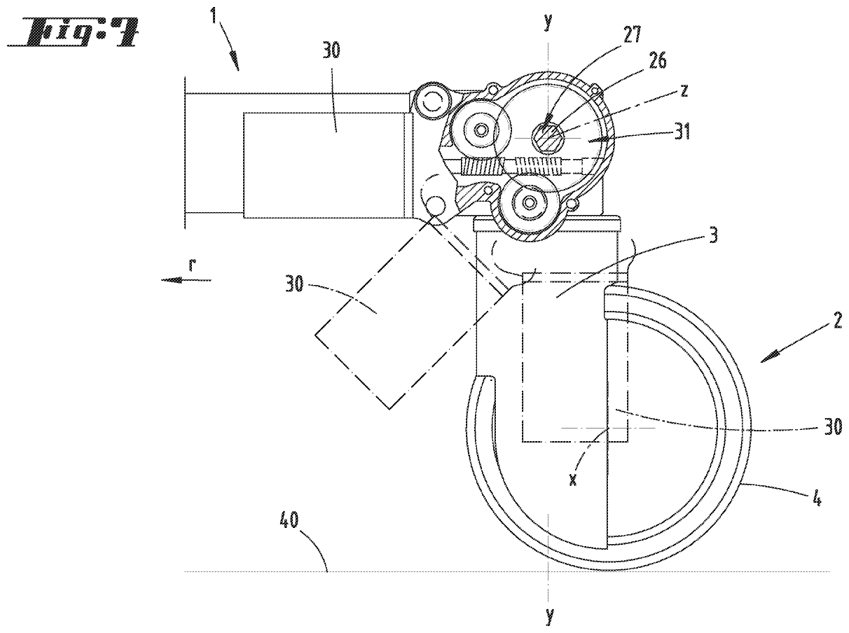

If the power source fails, for example due to exhausting the charge of accumulator 32, the usual functions of casters 2 (assuming the total locking, assuming the running direction locking, and assuming the free running and pivoting position) may still be carried out. For this purpose, optionally, after deliberately releasing an otherwise effective locking mechanism, electric motor 30, which is radially aligned and exposed to actuating shaft 26, may be used as a handle in order to manually carry out a rotary actuation of actuating shaft 26 and thus a rotary actuation of cam parts 20, subjected as a whole to rotational pressure via the actuating shaft 26 and, optionally, shift linkage 27 (see dash-dotted line depictions in FIG. 7). Reference is also made to the aforementioned WO 02/055322 A1, for example, with regard to this emergency actuation.

Aforementioned controller 5 may be accommodated in a housing 34 arranged in an easily accessible way, for example, in a handling area 33 of the movable part 1. The power supply for the controller, as well as for other electronic components, is provided by accumulator 32.

Controller 5 may be intentionally actuated by an operator as a result of a triggering event, for which purpose the system as a whole may be kept, in principle, in a standby mode.

The triggering event, for example a switch actuation by the operator, may, as is also preferred, be preceded by a safety check. Such a safety check may be carried out simultaneously, where appropriate, using a sensor 35, for example, provided on housing 34. With regard to sensor 35, this may be a fingerprint sensor, for example; alternatively, however, it may also be a face or iris scanner, for example. In the comparison with stored data, for example in a database, a release of controller 5 is enabled after a successful security check. Such a check may also directly be the triggering event, so that controller 5 may be activated simultaneously with a successful check.

Alternatively to such a sensor 35, a transponder may also be provided, for example also arranged on the housing 34. As another alternative, an authorized release may be carried out, for example, by entering a code.

After an appropriate activation, controller 5 monitors a displacement of movable part 1 via control electronics 36. For this purpose, movable part 1 is provided with a movement sensor 37. This may be arranged on the chassis side; however, it may also be accommodated in housing 34. Movement sensor 37 does not merely register a displacement of movable part 1, instead it also registers the selected direction of travel.

The values recorded via movement sensor 37 are evaluated using control electronics 36. If the same or approximately the same movement values are recorded and evaluated via movement sensor 37 within a predetermined period of time of a few seconds, for example 3 to 5 seconds, where appropriate, also within longer periods of time of up to 20 or 30 seconds or more, controller 5 effects a change of the switching state to the electric motor drive, provided that the current switching state does not already correspond to the switching state that is to be preferably assumed based on the evaluation.

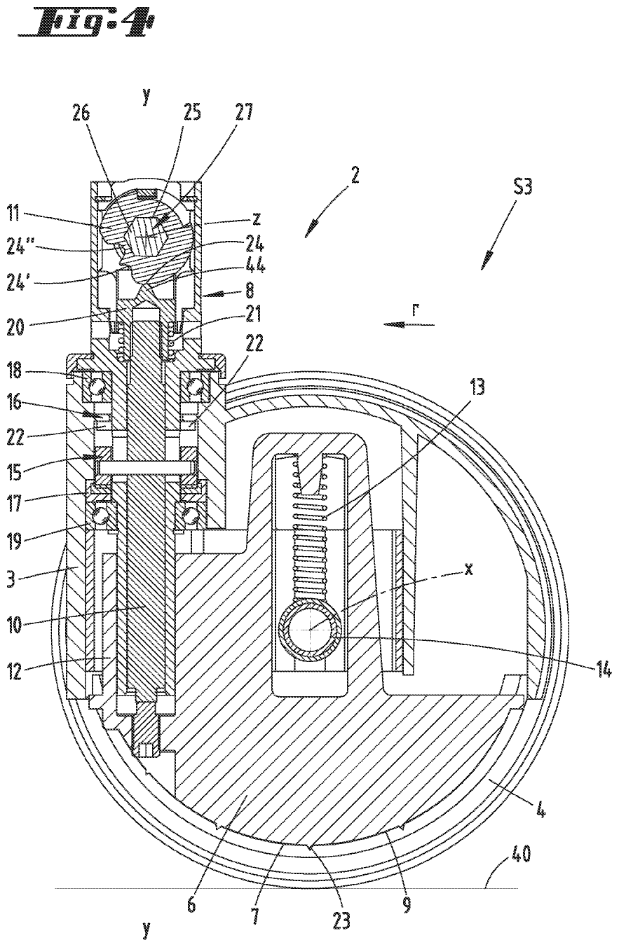

Before triggering the control sequence, the third switching state (S3 in FIGS. 3 and 4 and depiction in FIG. 4) is preferably present, in which one or more or, as preferred in the exemplary embodiment, all casters 2 are locked against both pivoting and also rotation. A total locking prevails.

When the control sequence is triggered, for example by switch actuation and/or by proof of an authorization, for example by means of a sensor 35, a signal is automatically transmitted via control electronics 36, which causes electric motor 30 to actuate actuating shaft 26, if necessary entire shift linkage 27, in such a way that, via cam parts 20, respective switching formation 24′ comes into operation with cam part 20 of actuating tappet 10 such that both engagement part 15 and locking device 6 of caster 2 lose their positive-locking and/or frictional position on support housing 3 or on wheel 4. Caster 2 may then be pivoted freely about pivot axis y, with wheel 4 freely rotating about axis of rotation x.

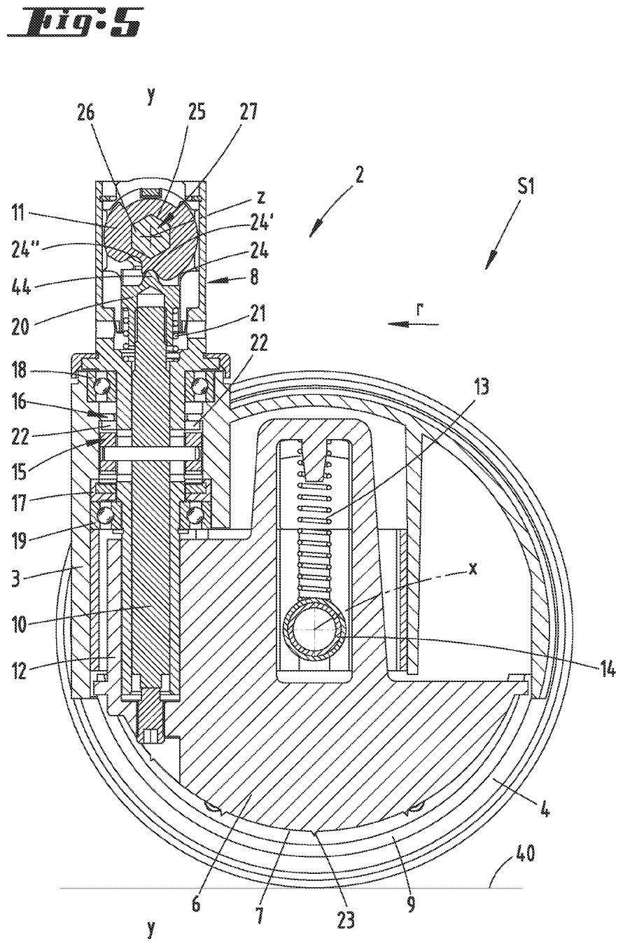

Correspondingly, in this first switching state (S1 in FIGS. 3 and 4 and depiction in FIG. 5), movable part 1 may be moved freely immediately after triggering the control sequence. This state is further monitored by controller 5, based on the evaluation of the values detected by motion sensor 37.

If no movement is detected by movement sensor 37 within a predetermined period of time, the third switching state (total locking) may be immediately brought about again via controller 5.

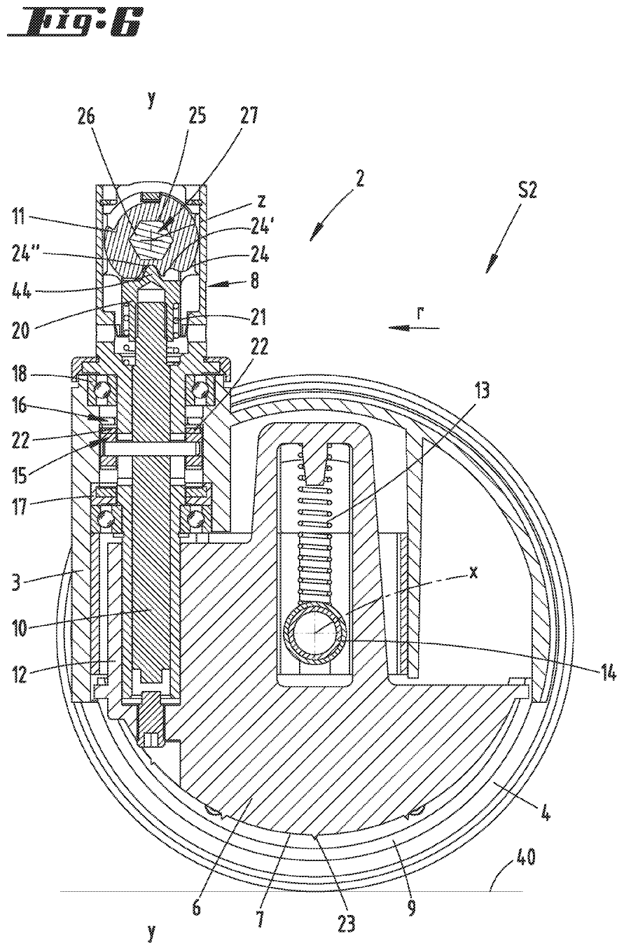

If, in contrast, (only) a straight-line travel of the movable part 1 is detected in a predetermined period of time, controller 5 then automatically initiates the corresponding activation of electric motor 30 in order to displace respective cam part 20, via this activation and via shift linkage 27, in such a way about axis of rotation z that switching formation 24″ now comes into effect. In this cam part position, the second switching state is assumed (S2 in FIGS. 3 and 4 and depiction in FIG. 6), in which wheel 4 may continue to rotate freely about its axis of rotation x; however, pivoting about vertical pivot axis y is prevented. Caster 2 in this switching position functions as a type of fixed caster, which supports straight-line travel in an advantageous way.

The movement monitoring is continuous. Correspondingly, if, in an assumed second switching state S2, a stopping of movable part 1 is also detected over a predetermined period of time and evaluated as such, this may preferably result, in the automatic control sequence, in a switch back from second switching state S2 into first switching state S1 with a freely movable caster 2.

If, after a predetermined period of time has elapsed, no movement of movable part 1 is detected, a switch into third switching state S3 takes place automatically, which means that one or all of casters 2 are located in the total locking position. Starting from this third switching state S3, a restart of the control sequence may preferably be carried out only after renewed, intentional activation by the operator. More preferably, such a renewed activation may only be necessary after a predetermined period of time has elapsed.

In a further embodiment, first switching state S1 may be reached directly from the second switching state S2 (directional locking position), for example, by actuating a switch, bypassing the expiration of the predetermined period of time, for example, in order to maneuver movable part 1 after a straight-line travel without waiting for the predetermined period of time to pass in an idle position of movable part 1.

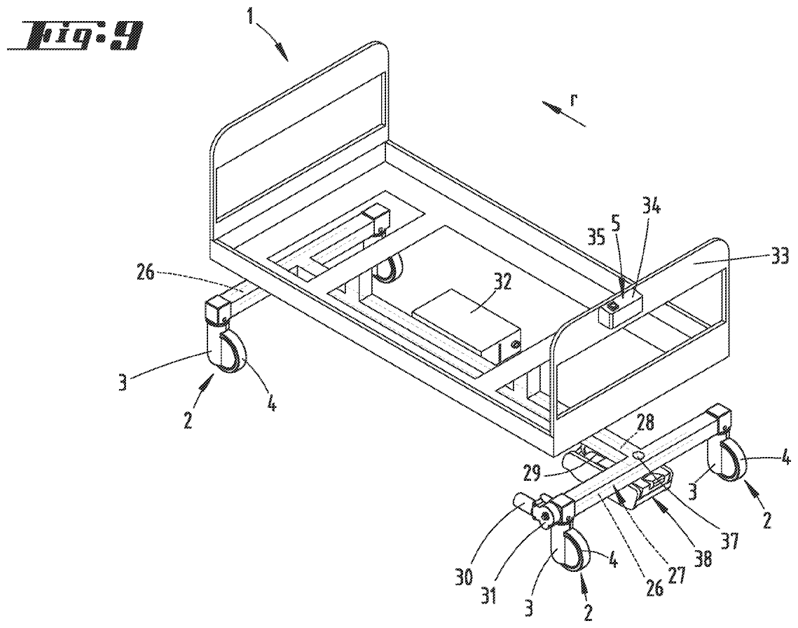

FIGS. 9 to 11 show a second embodiment of a movable part 1, in which, where appropriate, only wheel 4 of respective caster 2 may be effected via the controller 5 and electric motor 30. Thus, with respect to casters 2, where appropriate, only two switching states may be assumed, namely a switching state in which wheel 4 is freely rotatable about axis of rotation x, and a switching state in which wheel 4 is rotationally blocked. Independently of this, respective caster 2 may preferably rotate freely about vertical pivot axis y in each switching position. Alternatively, and also according to the first embodiment, one or more casters 2 may also assume a total locking position.

Moreover, movable part 1 of this second embodiment has a fifth caster as an additional caster 38. Its running wheel 39 has only one predetermined running direction, namely a running direction aligned in the usual direction of travel r.

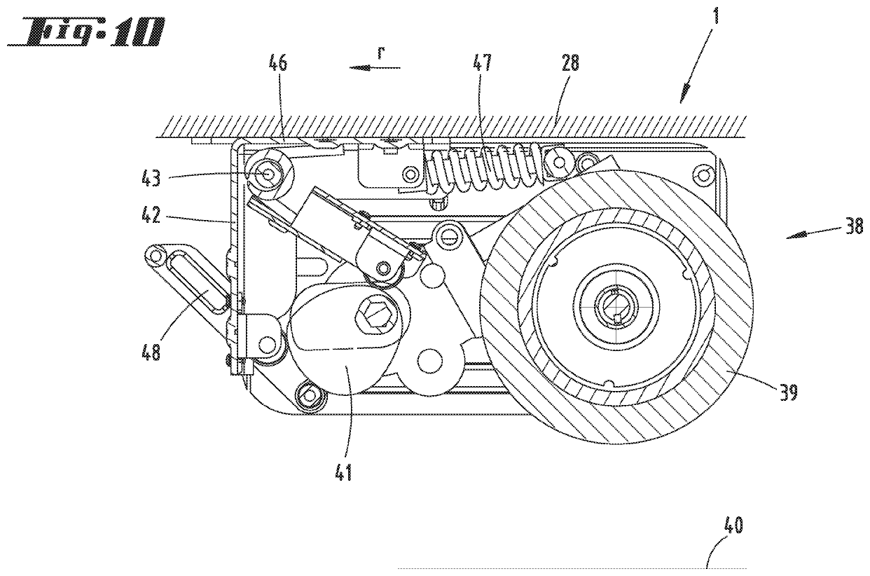

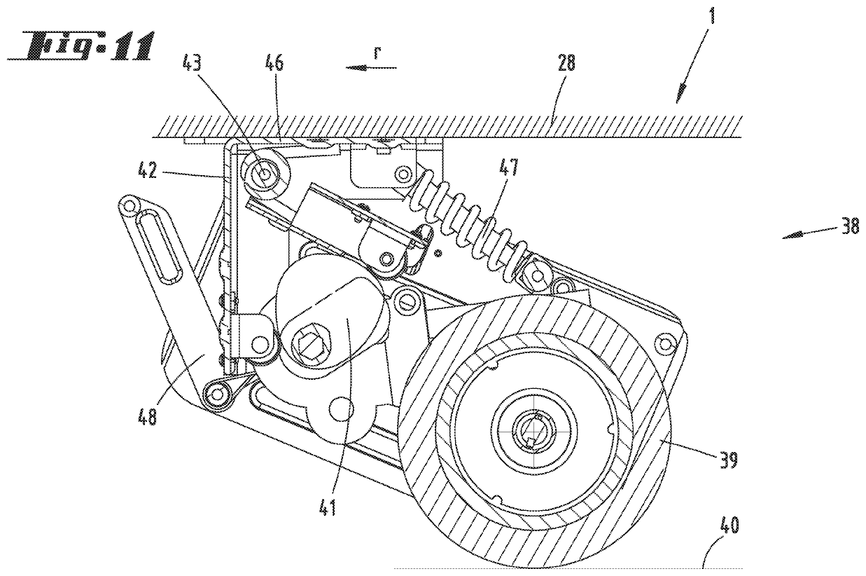

Additional caster 38 may be movable between a raised position in FIG. 10 and a lowered position in FIG. 11, such that correspondingly, additional caster 38 is lowered to floor 40, where appropriate, solely to support a straight-line travel according to switching state S2 of the first embodiment.

Preferably, as also depicted, an arrangement of additional caster 38 is assigned to the rear area of movable part 1 in direction of travel r, corresponding to a central vertical plane of movable part 1, opposite direction of travel r, spaced apart in the direction of handling area 33.

Such an additional caster is known, for example, from WO 2007/093549 A1 (US 2010/0181122 A1) or also from WO 2012/110283 A1 (US 2013/0299252 A1), the disclosures of which are all herein incorporated by reference.

Additional caster 38 is provided with a separate electric motor, which preferably acts on an eccentric 41 via a transmission. When the electric motor is activated and eccentric 41 is rotated as a result, running wheel 39 accommodated in a housing 42, preferably together with housing 42, is pivotally displaced about a fixed pivot axis 43 until it is displaced into a lowered position touching floor 40 or into a preferably stop-delimited, raised position.

Housing 42 of additional caster 38 may be fastened to the chassis of movable part 1 on the underside of crossbeam 29, for example, via a mounting plate 46, and may also be fastened with screws, for example.

Furthermore, a compression spring 47 may be provided, which is supported on housing 42 or on mounting plate 46 at one end and acts against a frame carrying running wheel 39 at the other end. The arrangement of compression spring 47 may, as is also preferred, be selected so that it supports the respective position of running wheel 39, both in the raised position and in the lowered position, in that compression spring 47 presses the frame supporting running wheel 39 into the raised position or—in the lowered position—presses running wheel 39 on ground 40 via the frame.

In addition, an actuating lever 48 may be a component of additional caster 38, via which a raising of running wheel 39 may achieved manually, where appropriate, for example if the electric motor drive fails.

In a further embodiment, running wheel 39 of additional caster 38 may be driven by an electric motor, so that in the lowered position a movement of movable part 1 is supported. For this purpose, additional caster 38 may have a separate electric motor.

To achieve second switching state S2, additional caster 38 is brought into the lowered position.

### LIST OF REFERENCE NUMERALS

1 Movable part
2 Caster
3 Support housing
4 Wheel
5 Controller
6 Locking device
7 Interacting surface
8 Mounting pin
9 Wheel inner surface
10 Actuating tappet
11 Cam wheel
12 Guide sleeve
13 Return spring
14 Wheel axle
15 Engagement part
16 Counterpart
17 Counterpart
18 Roller bearing
19 Roller bearing
20 Cam part
21 Tappet return spring
23 Tooth formation
24 Switching formation
24′ Switching formation
24″ Switching formation
25 Socket
26 Actuating shaft
27 Shift linkage
28 Push rod
29 Crossbeam
30 Electric motor
31 Toothed transmission
32 Accumulator
33 Handling area
34 Housing
35 Sensor
36 Control electronics
37 Movement sensor
38 Additional caster
39 Running wheel
40 Floor
41 Eccentric
42 Housing
43 Pivot axis
44 Cam
45 Lever arm
46 Mounting plate
47 Compression spring
48 Actuating lever
r Direction of travel
x Axis of rotation
y Pivot axis
z Axis of rotation
S1 Switching state
S2 Switching state
S3 Switching state

1-16. (canceled)

17. A system comprising two or more casters and a controller, wherein the casters (2) are attached to a movable part (1) such as a hospital bed, wherein the two or more casters (2) are switchable by the controller by means of a switching device (36) for switching the casters (2) between a state in which one or more of the casters (2) is pivot locked and a wheel (4) of the caster (2) is rotationally blocked and a state in which there is neither a pivot locking nor a rotational blocking, wherein furthermore one of the casters (2) is additionally switchable into a state in which the one caster (2) is only pivot locked, wherein the switchable casters (2) are configured to be actuated electrically and also manually in the event of a failure of an electric drive or a plurality of such electric drives or in the event of a failure of an electrical supply, in order to be able to carry out an emergency switching actuation of one or more or all casters (2), and the movable part (1) has a movement sensor (37), wherein the system is configured such that starting from a state in which the switchable casters (2) are pivot locked and rotationally blocked, following a triggering event, multiple switching states may be automatically and sequentially assumed in a predetermined sequence by the switchable casters (2), wherein a first switching state (S1) transfers all casters (2) into the state in which there is neither a pivot locking nor a rotational blocking, which a second switching state (S2) may automatically follow, in which one or more or all casters (2) are pivot locked, however their wheels (4) are not rotationally blocked, and finally a switching state (S3) follows, after the expiration of a predetermined period of time and an absence of a detection of a movement of the movable part (1), in which all switchable casters (2) are again transferred into the state in which they are pivot locked and rotationally blocked, and wherein the triggering event is a switch actuation by an operator.

18. A system comprising two or more casters and a controller, wherein the casters (2) are attached to a movable part (1) such as a hospital bed, wherein the two or more casters (2) are switchable by the controller by means of a switching device (36) for switching the casters (2) between a state in which one or more of the casters (2) is pivot locked and a wheel (4) of the caster (2) is rotationally blocked and a state in which there is neither a pivot locking nor a rotational blocking, wherein furthermore one of the casters (2) is additionally switchable into a state in which the caster (2) is only pivot locked, wherein the switchable casters (2) are configured to be actuated electrically and also manually in the event of a failure of an electric drive or a plurality of such electric drives or in the event of a failure of an electrical supply, in order to be able to carry out an emergency switching actuation of one or more or all casters (2), and the movable part (1) has a movement sensor (37), wherein the system is configured such that starting from a state in which the switchable casters (2) are pivot locked and rotationally blocked, following a triggering event, multiple switching states may be automatically and sequentially assumed in a predetermined sequence by the switchable casters (2), wherein a first switching state (S1) transfers all casters (2) into the state in which there is neither a pivot locking nor a rotational blocking, which a second switching state (S2) may automatically follow, in which one or more or all casters (2) are pivot locked, however their wheels (4) are not rotationally blocked, and finally a switching state (S3) follows, after the expiration of a predetermined period of time and an absence of a detection of a movement of the movable part (1), in which all switchable casters (2) are again transferred into the state in which they are pivot locked and rotationally blocked, and wherein the triggering event is a switch actuation by an operator and wherein the triggering event is only effective after a security check.

19. The system according to claim 17, wherein the triggering event is only effective after a security check.

20. The system according to claim 18, wherein the security check can be carried out by means of a finger sensor (35) and/or a transponder and/or by entering a code.

21. The system according to claim 17, wherein the switchable casters (2) are configured to be switched via a shift linkage (27).

22. The system according to claim 17, wherein after a successful triggering of the sequence and given that one or more casters (2) is/are directionally locked, the directional lock can be released again by repeating the triggering event or by a separate actuation including a separate switch actuation, whereupon all casters (2) are in the release position.

23. The system according to claim 22, wherein the repetition of the triggering event is effective during the automatic sequence of the switching states without a safety check.

24. The system according to claim 17, wherein the predetermined sequence includes a predetermined time period between the respective switching states.

25. The system according to claim 17, wherein the two or more casters comprises at least three casters, and further comprising a fourth or fifth caster forming an an additional caster (38) which has only one predetermined running direction.

26. The system according to claim 25, wherein the additional caster (38) is movable between a lowered and a raised position.

27. The system, according to claim 25, wherein the additional caster (38) is drivable.

28. A method for controlling casters (2) attached to a movable part (1), such as a hospital bed, wherein two or more casters (2) are switchable by means of a switching device (36) for switching the casters (2) between a state in which one or more of the casters (2) is pivot locked and a wheel (4) of the caster (2) is rotationally blocked and a state in which there is neither a pivot locking nor a rotational blocking, wherein furthermore one of the casters (2) is additionally switchable into a state in which the one caster (2) is only pivot locked, wherein the switchable casters (2) are configured to be actuated electrically and also manually and the movable part (1) has a motion sensor (37), the method comprising
actuating a switch by which a previously determined sequence of different switching states (S1, S2, S3) of the casters (2) is triggered to obtain a desired movement of the movable part (1) using the casters (2) on the movable part (1), the steep of actuating enacting a triggering event, wherein all casters (2) are initially transferred into a release position, which an automatic pivot locking of one or more or all casters (2) can follow, and finally, after an absence of a detection of a movement of the movable part, all casters (2), which are switchable between a rotational blocking and pivot locking and a release position, are switched into the rotational blocking and pivot locking.

29. A system comprising two or more casters and a controller, wherein the casters (2) are attached to a movable part (1) such as a hospital bed, wherein the two or more of casters (2) are switchable by the controller by means of a switching device (36) for switching the casters (2) between a state in which the caster (2) is pivot locked and a wheel (4) of the caster (2) is rotationally blocked and a state in which there is neither a pivot locking nor a rotational blocking, wherein furthermore one of the casters (2) is additionally switchable into a state in which the one caster (2) is only pivot locked, wherein the switchable casters (2) can be actuated electrically and also manually in the event of a failure of an electric drive or a plurality of such electric drives or in the event of a failure of an electrical supply, in order to be able to carry out an emergency switching actuation of one or more or all casters (2), and the movable part (1) has a movement sensor (37), wherein, the system is configured such that with respect to a desired movement of the movable part (1) using the casters (2) on the movable part (1), a triggering event is enacted by actuating a switch by which means a previously determined sequence of different switching states (S1, S2, S3) of the casters (2) is triggered, wherein all casters (2) are initially transferred into a release position, which an automatic pivot locking of one or more or all casters (2) can follow, and finally, after an absence of a detection of a movement of the movable part, all casters (2), which are switchable between a rotational blocking and pivot locking and a release position, are switched into the rotational blocking and pivot locking, and wherein the triggering event is only effective after a security check.

30. The method according to claim 28, wherein the triggering event is only effective after a security check.

31. The method according to claim 28, wherein the switchable casters (2) are switched via a shift linkage (27).

32. The method according to claim 28, wherein after a successful triggering of the sequence and given that one or more casters (2) is/are directionally locked, the directional lock is released by repeating the triggering event or by a separate actuation including a separate switch actuation, whereupon all casters (2) are in the release position.
